(19) United States
(12) Patent Application Publication
(10) Pub. No.: US 2019/0359295 A1
(43) Pub. Date: Nov. 28, 2019

(54) Device and Method for Reeling in a Cable from a Source and Temporarily Storing the Cable

(71) Applicant: Tideway B.V., Breda (NL)

(72) Inventors: Marco Martinus Maria Gremmen, Berghem (NL); Jeroen Jaspers, Wilrijk (BE); Lucas Adriaan Maria Bols, Ravels (BE)

(21) Appl. No.: 16/477,683

(22) PCT Filed: Jan. 16, 2018
(86) PCT No.: PCT/NL2018/050030

§ 371 Date: Jul. 12, 2019

(30) Foreign Application Priority Data
Jan. 16, 2017 (NL) 2018179

(51) Int. Cl. B63B 35/04; H02G 1/10; H02G 9/02; B65H 75/08

(52) U.S. Cl. CPC B63B 35/04; H02G 1/10; B65H 54/10; B65H 75/08; H02G 9/02

(57) ABSTRACT

A device for reeling in a cable and temporarily storing the cable is described. The device comprises first and second storage units, each comprising a cylindrical body for arranging the cable, as well as support means for carrying the cable from the source to cable seizing means of the second storage unit and further to the first storage unit. The second storage unit is rotatable around a rotation axis parallel to the cylinder longitudinal axis in a reeling direction. The storage units are arranged such that the second storage unit when rotating in the reeling direction can simultaneously reel in a part of the seized cable originating from the source and another part of the seized cable originating from the first storage unit. A method for reeling in the cable is also described. The device and method allow storing an increased amount of cable on a cable laying vessel for instance.

### BACKGROUND OF THE INVENTION

The present invention relates to a device for reeling in a cable from a source and temporarily storing the cable. The invention further relates to a floating structure comprising the device, to a method for reeling in a cable from a source and temporarily storing the cable, and to a method for laying a cable on or in a sea bed using the floating structure.

There is an increasing demand for laying cables, such as data communication and electrical cables on or in a seabed or the bed of another body of water. Such cables desirably have as few connections as possible, since connections represent possible sources of interference or disruption in transmission of the signal. Further, repairing or installing these connections involves an appreciable amount of time and money.

The quantity of cable that can be stored on board of a vessel as one continuous length is limited however. Storage units for cables such as cable carousels for instance are limited in size because of space restrictions on board of a vessel. Deck space is limited but building up cable carousels in the height direction is also limited for reasons of the required stability of the vessel. Indeed, the centre of gravity should not rise to high.

It would be desirable to be able to reel in and store an increased amount of continuous cable on for instance a cable-laying vessel. It is an object of the present invention therefore to provide a device and method for reeling in a cable from a source and temporarily storing the cable that at least partly alleviates aforementioned and other disadvantages. Another object relates to providing a more efficient method for laying a cable on or in a sea bed using the floating structure.

The present invention may also be used for other purposes than laying cables, including on-shore purposes. It is for instance possible to use the invented device for increasing production capacity in cable manufacturing.

### BRIEF SUMMARY OF THE INVENTION

The invention provides a device in accordance with claim 1. The device for reeling in a cable from a source and temporarily storing the cable in particular comprises a first and a second storage unit, each comprising a cylindrical body for arranging the cable;

support means for carrying the cable from the source to cable seizing means of the second storage unit and further to the first storage unit; wherein the second storage unit is rotatable around a rotation axis parallel to the cylinder longitudinal axis in a reeling direction, in which the cable is reeled in from the source; and the storage units are arranged such that the second storage unit when rotating in the reeling direction can simultaneously reel in a part of the cable originating from the source and another part of the cable originating from the first storage unit.

The invented device allows storing an increased length of cable relative to known devices, and further does not require extensive modifications to for instance (the deck of) a cable laying vessel that is equipped with the device. The ability to store an increased length of continuous (non-interrupted) cable on such a vessel makes the cable laying operation more efficient; a longer trajectory may be followed with one vessel only.

In a preferred embodiment of the invention, a cylinder longitudinal axis of the first storage unit does not coincide with the rotation axis of the second storage unit. In such an embodiment, the first and second storage units are not positioned on top of each other. This is advantageous on a vessel or another floating structure, since a stacked configuration of the storage units would require a substantial height and/or the positioning of one storage unit on deck and another storage unit below deck of the vessel. The present embodiment allows positioning the storage units side by side, more preferably such that the cylinder longitudinal axis of the first and/or second storage unit extends in a vertical direction. The storage units may then conveniently be placed below deck, thereby saving deck space.

According to the invention at least one of the storage units is rotatable around a rotation axis parallel to the cylinder longitudinal axis in a reeling direction, in which the cable is reeled in from the source. The first storage unit however may be stationary if this is more convenient. In a preferred embodiment the first storage unit is also rotatable around a rotation axis parallel to the cylinder longitudinal axis in a reeling direction in which the cable is reeled in from the source. This allows reeling in the cable more efficiently.

The second storage unit comprises cable seizing means configured to at least temporarily seize or hold the cable in the second storage unit to facilitate simultaneously reeling in a part of the cable originating from the source and another part of the cable originating from the first storage unit when the second storage unit is set in rotation in the reeling direction.

An embodiment of the invention provides a second storage unit, the cable seizing means of which comprise a cylindrical core provided with a passage for the cable extending in a cross-direction of the core. A cable that is carried from the source to the second storage unit is passed through the passage from one side of the core to another (opposite) side of the core, and then carried further to the first storage unit. A rotation of the second storage unit will wind the cable around the (centrally) disposed core from opposite sides of the core. The core thus acts as a seizing means for the cable.

In another embodiment of the device, the cylindrical core may not be provided with a passage and the cable originating from the source is seized by looping it around the cylindrical core of the second storage unit.

In the above disclosed embodiments of the invention, the cable will experience some bending along a radius that may be close or equal to the radius of the cylindrical core.

Care should be taken not to make this radius too small to avoid bending the cable over a radius that is smaller than the minimum bending radius (MBR) of the cable. The MBR is provided by the manufacturer of the cable. The radius of the cylindrical core is preferably equal to or larger than the MBR of the cable.

The device according to the invention comprises at least two storage units. Other embodiments however comprise more than two storage units arranged such that a storage unit n+1 when rotating in the reeling direction can simultaneously reel in a part of the cable originating from the source and another part of the cable originating from a storage unit n. The total length of stored cable may thus be increased.

The size of the storage units may be the same but an embodiment comprising storage units of different size, more preferably different circumferential size, is preferred. Such embodiment has shown to yield a higher efficiency.

The storage units may be of any known type, and suitable embodiments of the device provide first and/or second storage units comprising a reel, a carousel, a turntable or a static tank, or a combination of these.

The invention in another aspect comprises a floating structure that is provided with a device as described herein, which is preferably provided with a deck and at least two of the storage units are arranged below the deck. This allows saving deck space and a larger part of the deck can be used for other purposes, such as the storage of machines or other materials such as stones to cover the cable after laying, or protective sleeves for the cable. The device according to the invention is particularly suitable for installation on a vessel for laying cables on or in a sea bed.

In yet another aspect, the invention concerns a method for reeling in a cable from a source and temporarily storing the cable, the method comprising providing a first and a second storage unit, each comprising a cylindrical body for arranging the cable; carrying the cable on support means from a source to cable seizing means of the second storage unit and further to the first storage unit; reeling in the cable on the first storage unit to a first filling degree; rotating the second storage unit around a rotation axis parallel to the cylinder longitudinal axis in a reeling direction to simultaneously reel in a part of the seized cable originating from the source and another part of the seized cable originating from the first storage unit until a second filling degree of the second storage unit is reached.

The invented method allows to additionally storing some 50% or more of uninterrupted cable length, as compared to one storage unit only.

Preferred embodiments of the invention provide a method wherein a cylinder longitudinal axis of the first storage unit does not coincide with the rotation axis of the second storage unit; wherein the first and the second filling degree comprises a substantially 100% filling; wherein the first storage unit rotates around a rotation axis parallel to the cylinder longitudinal axis in a reeling direction to reel in the cable;

wherein the cable originating from the source is seized by passing it through a passage for the cable extending in a cross-direction of a cylindrical core of the second storage unit; wherein the cable originating from the source is seized by looping it around a cylindrical core of the second storage unit; wherein the method comprises more than two storage units arranged such that rotating a storage unit n+1 in a reeling direction simultaneously reels in a part of the seized cable originating from the source and another part of the seized cable originating from a storage unit n; comprising storage units of different circumferential size; and/or wherein the first and/or the second storage unit comprise a reel, a carousel, a turntable or a static tank, or a combination of these.

The method is preferably carried out on a floating structure, which floating structure in a more preferred embodiment has a deck and at least two of the storage units are arranged below the deck, and wherein the floating structure even more preferably comprises a vessel for laying cables on or in a sea bed.

In another aspect of the invention therefore, a method for laying a cable on or in a sea bed is provided, wherein a vessel for laying a cable on or in a sea bed is provided with a quantity of stored cable in accordance with the herein described method, the vessel sails on water and stored cable is unreeled from the first and second storage unit, brought overboard and laid on or in the sea bed.

It is explicitly mentioned that the embodiments disclosed in the present application may be combined in any possible combination of these embodiments, and that each separate embodiment may be the subject of a divisional application.

### BRIEF DESCRIPTION OF THE DRAWINGS

The invention will now be described in more detail by reference to the attached figures, without however being limited thereto. In the figures:

FIG. 1 schematically shows a perspective view of a rear deck part of a cable laying vessel according to one embodiment of the invention, wherein the deck is made transparent to show the below deck area;

FIG. 2 schematically shows a perspective view of two storage units according to an embodiment of the invention;

FIG. 3 schematically shows a number of method steps in accordance with an embodiment of the invention;

FIG. 4 schematically shows a number of method steps in accordance with another embodiment of the invention;

FIG. 5 schematically shows a side view of storage units in accordance with several embodiments of the invention;

FIG. 6 schematically shows an isometric and side view of cylindrical cores of second storage units and possible cable paths according to the invention;

FIG. 7 shows a graph of the uninterrupted cable length that can be stored in view of the number of storage units used in accordance with several embodiments of the invention; and finally FIG. 8 shows a graph of the uninterrupted total cable capacity that can be stored in view of the ratio of a smallest to largest storage unit used in accordance with several embodiments of the invention.

### DETAILED DESCRIPTION OF THE PREFERRED EMBODIMENTS

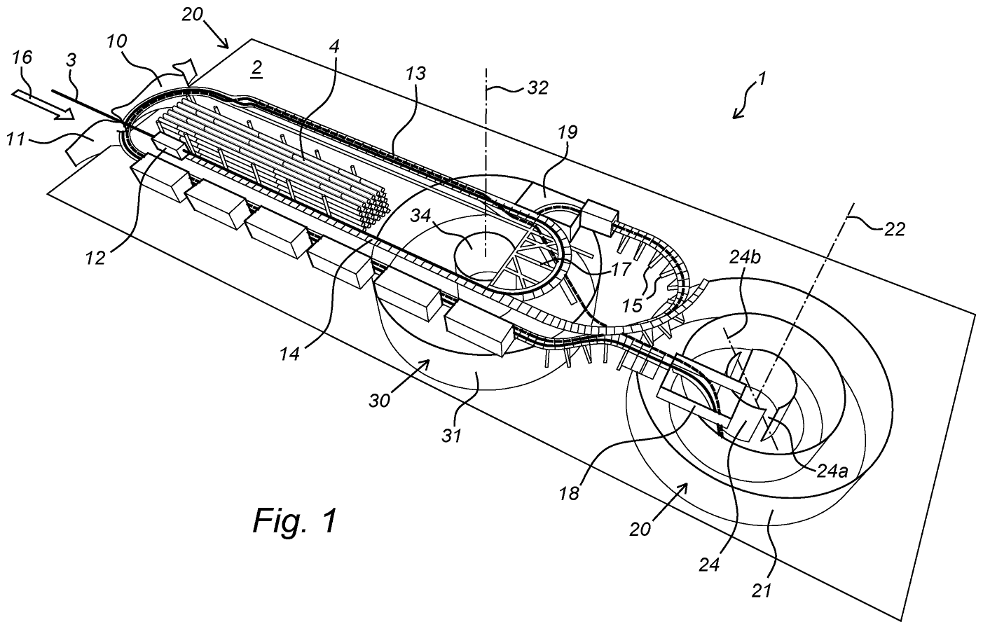

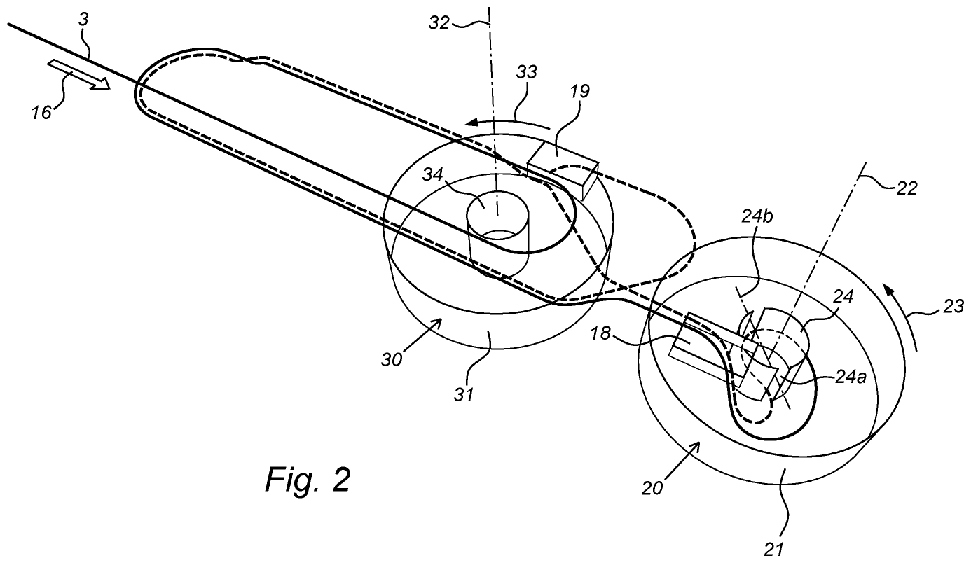

Referring to FIG. 1, a part of the deck 2 of a vessel 1 for laying cables 3 on or in a sea bed is shown. The vessel 1 is at a rear side 20 of the deck 2 provided with a portside chute 10 and a starboard chute 11 for guiding a cable 3. The chutes (10, 11) may be used to reel in a cable 3 from a suitable source, such as an onshore cable rack (not shown), but may also be used to bring out of board cable 3 during a cable laying operation off shore. A cable tensioner 12 may be present to pull the cable 3 along support means in the form of port side and starboard cable trays (13, 14). The cable trays (13, 14) are supported by poles 15 to elevate and hold the trays above work deck level. A cable 3 that is pulled in from shore in the direction 16 is first led along a so-called quadrant 17. This is also shown in FIG. 2. The quadrant structure 17 guides a cable 3 along an arc with a radius that is equal or larger than the minimum bending radius (MBR) of the cable 3, this in order to prevent damaging or even breaking of the cable 3. As shown in FIGS. 1 and 2, the cable 3 is guided further from the quadrant 17 along the starboard cable tray 14 to a deck penetration 18 which offers access to a second storage unit 20 provided in an area below deck 2. Cable 3 surfaces from this deck penetration 18 again (see below) and is then led over the quadrant 17 and back to another deck penetration 19 giving access to a first storage unit 30 provided in an area below deck 2.

As further shown in FIG. 1, the storage units (20, 30) are arranged below the deck, and each of the storage units (20, 30) comprises a cylindrical body (21, 31) in which the cable 3 can be arranged in a circumferential direction. As shown, the cylinder longitudinal axis 22 of the second storage unit 20 does not coincide with the cylinder longitudinal axis 32 of the first storage unit 30, and both storage units (20, 30) are spaced apart from each other. In the embodiment shown, the cylinder longitudinal axes (22, 32) of the second and first storage unit (20, 30) extend in a direction about perpendicular to the plane of the deck 2. This direction is substantially vertical. Other directions are also possible.

The second storage unit 20 is rotatable around a rotation axis parallel to the cylinder longitudinal axis 22 in a reeling direction 23, in which the cable 3 is reeled in from the source. Likewise, the first storage unit 30 is rotatable around a rotation axis parallel to the cylinder longitudinal axis 32 in a reeling direction 33 in which the cable 3 is reeled in from the source.

The second storage unit 20 is further provided with cable seizing means that in the embodiment shown comprises a cylindrical core 24 provided with a passage 24a for the cable 3. The passage 24a extends in a cross-direction 24b of the cylindrical core 24. The first storage unit 30 may also be provided with a cylindrical core 34.

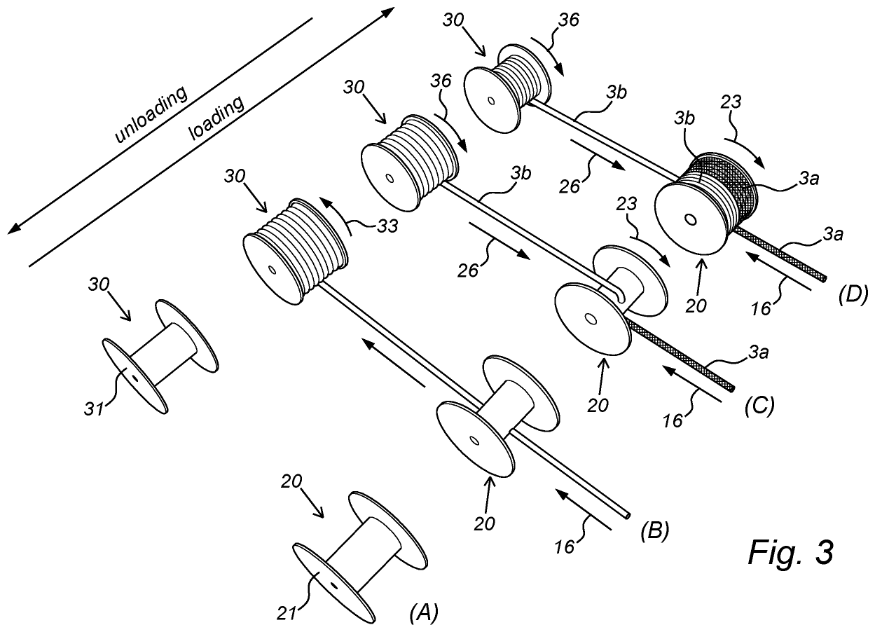

The principle of operation of the invented device can best be understood with reference to FIG. 3. The method for reeling in a cable 3 from a source and temporarily storing the cable 3 in a first step comprises (A) providing a first storage unit 30 and a second storage unit 20, each comprising a cylindrical body (31, 21) for arranging the cable 3. In a second step (B) the cable 3 is carried on the cable trays (13, 14) from a source through the passage 24a of the cylindrical core 24 of the second storage unit 20 and further to the first storage unit 30 and the cable is reeled in on the first storage unit 30 to a first filling degree, which in an embodiment is substantially a 100% filling, as shown. Reeling can be done by rotating the first storage unit 30 in the reeling direction 33. In a third step (C) the second storage unit 20 is rotated in its reeling direction 23 and, due to the fact that the cable 3 is caught by running through the passage 24a of its core 24, the second storage unit 20 in step (D) simultaneously reels in a part 3a of the seized cable 3 originating from the source in the direction 16 and another part 3b of the seized cable 3 originating from the first storage unit 30 in a direction 26. The first storage unit 30 in this process may be stationary or may rotate in a direction 36 opposite to its reeling direction 33. The second storage unit 20 is filled from the two sources until a second filling degree is reached, preferably until the second storage unit is filled for substantially 100%. The final filling degree of the first storage unit 30 will be less than 100% since a part 3b of the cable 3 was unreeled from the first storage unit 30 in the process.

When unreeling the stored cable 3, for instance in order to bring it overboard in a cable laying operation, the sequence of steps (A) to (D) is reversed and carried out in the sequence (D) to (A), as shown by the top arrows in FIG. 3.

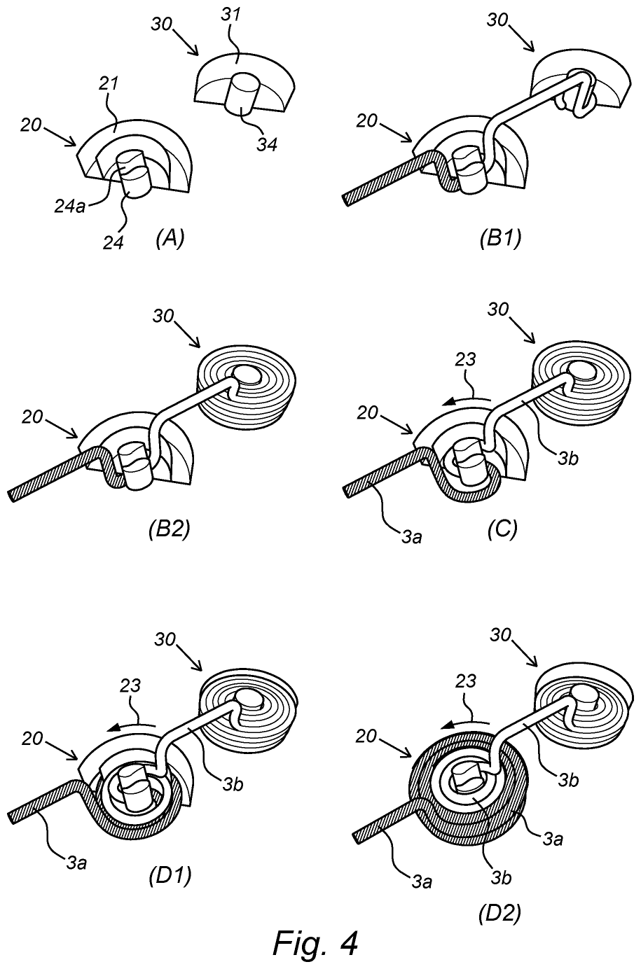

The above sequence can be carried out in any type of storage unit (20, 30). FIG. 4 for instance illustrates the method steps (A) to (D) for two carousels (20, 30) positioned side by side, wherein the first storage unit 30 may be stationary. A first step of the embodiment of the method shown comprises (A) providing a first storage unit 30 and a second storage unit 20, each comprising a cylindrical body (31, 21) for arranging the cable 3. In second steps (B1, B2) the cable 3 is carried on the cable trays (13, 14) from a source through the passage 24a of the cylindrical core 24 of the second storage unit 20 and further to the first storage unit 30 and the cable is reeled in on the first storage unit 30 to a substantially 100% filling. A third step (C) involves rotating the second storage unit 20 in its reeling direction 23 and, due to the fact that the cable 3 is caught by running through the passage 24a of its core 24, the second storage unit 20 in steps (D1, D2) simultaneously reels in a part 3a of the seized cable 3 originating from the source and another part 3b of the seized cable 3 originating from the first storage unit 30. The second storage unit 20 is filled from the two sources until a second filling degree is reached, preferably until the second storage unit is filled for substantially 100%. The final filling degree of the first storage unit 30 will be less than 100% since a part 3b of the cable 3 was unreeled from the first storage unit 30 in the process. Indeed, in the embodiment shown, the first storage unit 30 is now half full only. Therefore the total cable length spooled onto the storage units (20, 30) is 75% of the full capacity of the two storage units (20, 30) together. However, the cable is 150% longer than it could be if both storage units (20, 30) were filled completely, since this would require a cut in the cable 3.

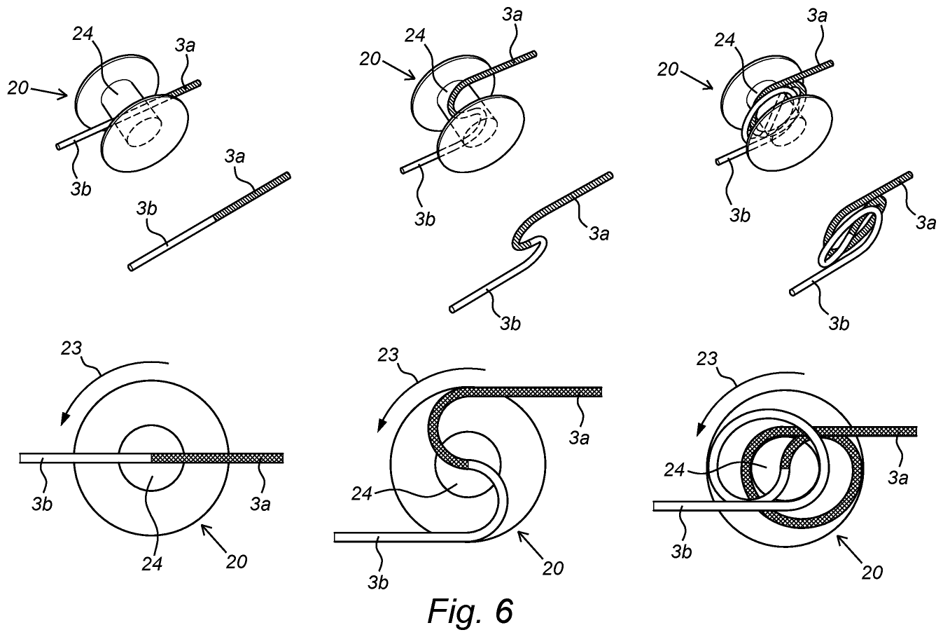

Step (B) of the method shown in FIG. 4 requires that the cable 3 is fed through the passage 4a of the core 4 of the second storage unit 20. As is more clearly shown in FIG. 6, this may involve some extreme bending of the cable 3, and care should be taken to prevent bending the cable over a radius that is lower than the minimum bending radius (MBR) of the cable 3. The invention however does not require the cable 3 to be fed through the core 4 of the second storage unit 20 (or other storage device). If acceptable from a minimum bending requirement, the cable 3 could also, as schematically shown in FIG. 6, be fed around the core (in case of a reel or carousel for instance) or across the first layer of a turntable. Feeding the cable 3 around the core 4 of a reel or carousel (20, 30) may sacrifice a part of the first layer laid. Bending the cable 3 around the core 24 of a storage unit (20, 30) may involve simultaneous biplanar cable bending, which may need to be prevented. The feasibility of bending the cable 3 around a core 24 may be determined by considering the cable's MBR and the dimensions of the storage unit (20, 30). A preferred storage unit (20, 30) comprises a turntable, described further below.

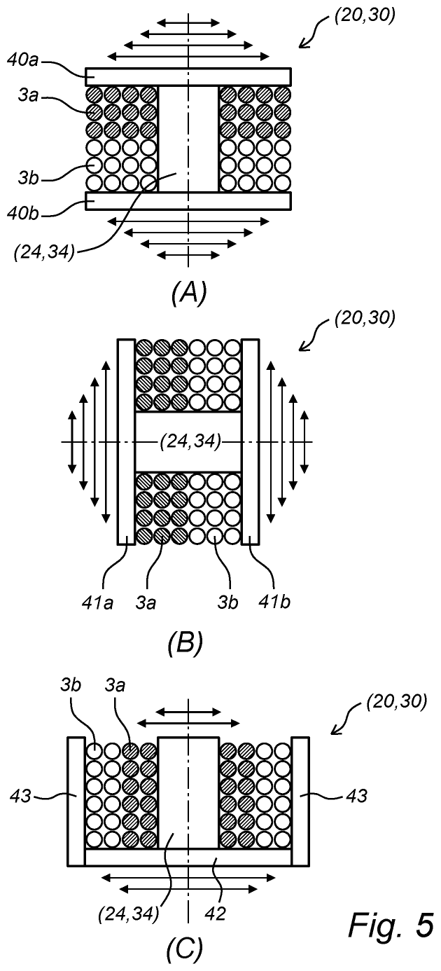

The storage units may comprise any structure suitable for temporarily storing a length of cable. As shown in FIG. 5, the storage devices may comprise a reel (FIG. 5B), a carousel (FIG. 5A), a turntable or a static tank (5C), or a combination of these.

Suitable definitions in the context of the invention are the following:

Efficiency: the efficiency of cable loading is defined as the actual total uninterrupted cable length spooled onto the total number of storage devices considered divided by the sum of the capacities of each individual storage device considered. When considering two storage units where one is completely full and one is half full, the efficiency is (50%+100%)/(100%+100%)=75%.

The carousel (20, 30) shown in FIG. 5A has a cylindrical core (24, 34) that is oriented substantially vertical, and carries a top and bottom flange (40a, 40b). A carousel may be driven in a rotation direction during loading and unloading a cable 3. The weight of the cable 3 is evenly distributed into the foundation through the bottom flange 40b.

Preferably some form of back tension is applied for decent spooling (loss of back-tension may cause an entire wrap or layer to drop down). A carousel is typically filled wrap by wrap, from core to outer diameter.

The reel (20, 30) shown in FIG. 5B has a horizontally oriented core shaft (24, 34) and two vertically disposed flanges (41a, 41b). A reel may be driven in a rotation direction during loading and unloading a cable 3. The weight of the stored cable 3 is transferred through bearings of the core shaft (24, 34). Preferably, some form of back tension is applied, counter-acting the effects of gravity, and a reel is typically filled layer by layer, from the core to the outer diameter.

The turntable, or alternatively static tank (20, 30), shown in FIG. 5C has a vertically disposed inner core (24, 34), surrounded by an outer cylindrical retaining wall 43, and a bottom flange 42. A turntable may be driven in a rotation direction during loading and unloading a cable 3, whereas the static tank is not rotated. The weight of the stored cable 3 is evenly distributed over the bottom flange 42 and transferred to a suitable foundation. Back tension is not necessary. A turntable or static tank is typically filled layer by layer, from bottom flange to top.

Although storage units are preferably cylindrical, they may adopt other shapes, such as oval shapes. They may be provided with specific storage unit properties, such as partitions and core extenders for instance.

The device according to the invention may comprise more than two storage units arranged such that a storage unit n+1 when rotating in the reeling direction can simultaneously reel in a part of the cable originating from the source and another part of the cable originating from a storage unit n.

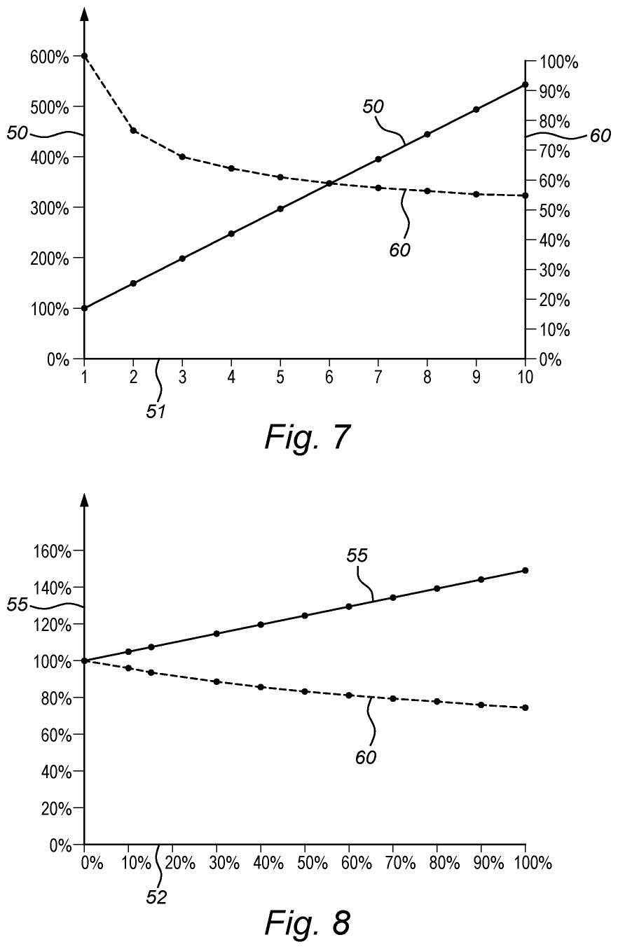

FIG. 7 illustrates the total uninterrupted cable length 50 spooled onto the total number of storage devices (as a percentage of the length for one storage device) and the efficiency 60 versus the number 51 of storage devices used. It can be concluded from this figure that a single storage device has the maximum efficiency of 100% of its capacity. Efficiency is seen to drop to 75% for two devices, 68% for three devices, and further to a limit value of 50% for larger numbers of devices. The total storage length however increases linearly with an increasing number of devices, each additional device adding 50% to the total storage length.

The device according to the invention may also comprise storage units of different circumferential size, for instance diameter.

FIG. 8 illustrates the total cable capacity 55 (as a percentage of the largest storage unit's capacity) as a function of the capacity ratio 52 of the smallest over the largest storage device (in percent). It can be concluded from this figure that the larger the capacity differences between two storage devices, the higher the efficiency. Further, two equally-sized storage devices have an efficiency of 75%. When selecting storage devices for a certain required capacity, it is most efficient to choose one storage device as large as possible and selecting the smallest possible device to contain the additionally required capacity.

A further efficiency increase may be obtained when at least two top-loading storage devices are used, such as turntables or static tanks. In such a configuration, cable is spooled from a first storage device to a second storage device near the core of said second storage device, while cable is also spooled from a source to the second storage device near the outside diameter of said second storage device. This configuration may yield an increased efficiency of 80% (relative to 75%). The efficiency gain may be attributed to the fact that a wrap or layer near the core of a storage device holds less cable length than a wrap or layer near the outer diameter of the storage device.

1.-23. (canceled)

24. A vessel for laying cables on or in a sea bed, comprising a device for reeling in a cable from a source and temporarily storing the cable, the device comprising
a first and a second storage unit, each comprising a cylindrical body for arranging the cable, wherein a cylinder longitudinal axis of the first storage unit does not coincide with a rotation axis of the second storage unit;
support means for carrying the cable from the source to cable seizing means of the second storage unit and further to the first storage unit;
wherein
the first storage unit is configured to reel in cable from the source;
the second storage unit is rotatable around the rotation axis parallel to the cylinder longitudinal axis in a reeling direction, in which the cable is reeled in from the source; and
the storage units are arranged such that the second storage unit when rotating in the reeling direction simultaneously reels in a part of the cable originating from the source and another part of the cable originating from the first storage unit, wherein further
the cable seizing means of the second storage unit comprise a centrally disposed cylindrical core and are configured to seize the cable such that a rotation of the second storage unit winds the cable around the centrally disposed core from opposite sides of the core, and
the centrally disposed core of the cable seizing means is provided with a passage for the cable extending in a cross-direction of the core.

25. The vessel according to claim 24, wherein the cylinder longitudinal axis of the first and/or second storage unit extends in a vertical direction.

26. The vessel according to claim 24, wherein the first storage unit is rotatable around a rotation axis parallel to the cylinder longitudinal axis in a reeling direction in which the cable is reeled in from the source.

27. The vessel according to claim 24, comprising more than two storage units arranged such that a storage unit n+1 when rotating in the reeling direction can simultaneously reel in a part of the cable originating from the source and another part of the cable originating from a storage unit n.

28. The vessel according to claim 24, comprising storage units of different circumferential size.

29. The vessel according to claim 24, wherein the first and/or the second storage unit comprises a top-loading storage device, such as a turntable or a static tank, or a combination of these.

30. The vessel according to claim 24, wherein the vessel has a deck and at least two of the storage units are arranged below the deck.

31. A method for reeling in a cable from a source and temporarily storing the cable on a vessel for laying cables on or in a sea bed, the method comprising
providing a first and a second storage unit on the vessel, each comprising a cylindrical body for arranging the cable;
carrying the cable on support means from a source to cable seizing means of the second storage unit and further to the first storage unit;
reeling in the cable on the first storage unit to a first filling degree;
rotating the second storage unit around a rotation axis parallel to the cylinder longitudinal axis in a reeling direction to simultaneously reel in a part of the seized cable originating from the source and another part of the seized cable originating from the first storage unit until a second filling degree of the second storage unit is reached, wherein a cylinder longitudinal axis of the first storage unit does not coincide with the rotation axis of the second storage unit; wherein the cable seizing means of the second storage unit comprise a centrally disposed core and seize the cable such that a rotation of the second storage unit winds the cable around the centrally disposed core from opposite sides of the core; wherein the centrally disposed core of the cable seizing means is provided with a passage extending in a cross-direction of the core and the cable is seized by the seizing means by providing it through the passage.

32. The method according to claim 31, wherein the first and the second filling degree comprises a substantially 100% filling.

33. The method according to claim 31, wherein the first storage unit rotates around a rotation axis parallel to the cylinder longitudinal axis in a reeling direction to reel in the cable.

34. The method according to claim 31, wherein the cable originating from the source is seized by looping it around a cylindrical core of the second storage unit.

35. The method according to claim 31, comprising more than two storage units arranged such that rotating a storage unit n+1 in a reeling direction simultaneously reels in a part of the seized cable originating from the source and another part of the seized cable originating from a storage unit n.

36. The method according to claim 31, comprising storage units of different circumferential size.

37. The method according to claim 31, wherein the first and/or the second storage unit comprise a reel, a carousel, a turntable or a static tank, or a combination of these.

38. The method according to claim 31, wherein the vessel has a deck and at least two of the storage units are arranged below the deck.

39. A method for laying a cable on or in an sea bed, wherein a vessel according to claim 24 is provided with a quantity of stored cable, the vessel sails on water and stored cable is unreeled from the first and second storage unit, brought overboard and laid on or in the sea bed.
